(19) United States
(12) Patent Application Publication
(10) Pub. No.: US 2008/0109651 A1
(43) Pub. Date: May 8, 2008

(54) System and methods for digital file management and authentication

(76) Inventors: Carl Duda, New York, NY (US); Wayne Kuan, Princeton, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/591,571

(22) Filed: Nov. 2, 2006

(51) Int. Cl. H04L 9/00

(52) U.S. Cl. 713/153

(57) ABSTRACT

A system and method for authenticating a file in a data processing system is provided. The data processing system includes a digital file management (DFM) server, an electronic postmark (EPM) server, a sender, and at least one intended recipient. A file is received from a sender through a computing device, and an EPM is acquired from the EPM server. The EPM is embedded in the file, and then the file with the EPM is provided to the intended recipient.

### FIELD OF THE INVENTION

The present invention generally relates to digital file management systems and more particularly to a web service application and network for digital file delivery and authentication.

### BACKGROUND

Digital files, or digital documents, are used to represent various types of information in a digital format. For example, an audio file may be used to hold information for the playing of music, an image file may contain a picture, an executable file may hold instructions for a microprocessor, etc. A computer-readable medium, such as a magnetic hard drive, CD-ROM, DVD, magnetic tape, etc., may be used to store digital files. The storage of information in digital files is increasingly used in many industries, partly because of the increased availability of enabling technology and partly due to the many advantages offered over conventional storage methods including: reduced storage space, increased access speed, focused retrievability (e.g., search capabilities), the ability to conveniently make “multiple” and “backup” copies of documents, and the ability to transfer or transmit documents quickly.

One drawback of storing information in digital files is the inherent ability of digital files to be altered, for example, with a purpose to defraud. For example, although an original paper document can be tampered with, such tampering (erasure or additions) will typically leave telltale evidence; digital representations of those documents, in the form of word processor documents or digital images for example, can be altered leaving no such evidence. Thus, where the authenticity of information is critical and may come into question (e.g., legal and medical fields), use of digital information is often not preferred, not acceptable or not admissible and therefore often avoided.

A computer user may wish to ensure that files are not altered. A proposed solution is the use of Write-Once, Read-Many (“WORM”) optical media to files. One advantage of WORM media storage is that the data it houses is inherently unalterable-data can be written only one time to the medium. However, this approach has several disadvantages as well. For example, data recorded on WORM media can be copied from the WORM disk of original recording to re-writable media, altered, and then recorded on new WORM disk with no traceability of such events.

Additionally, although it can be stated with great confidence that data on any one particular WORM disk has not been altered since it was recorded on that disk, the date and time when the data was recorded or whether the data matches an “original” of any kind cannot be determined with any certain or definitive means.

A known advance in file verification technology provides for registration of an “electronic signature” of a digital file. It is known to allow a user to locally select a file and locally run a program provided by a service provider to create an “electronic signature” of the selected digital file based solely on file content. The signature along with a user-provided file name and user-selected keywords are uploaded to the provider's site and stored in a registration database maintained by the service provider under an account established for the particular user. One particular provider generates a “certificate of registration” showing, inter alia, the signature.

Another known advance in this field is the United States Postal Service's (USPS) electronic postmark (EPM) service, which provides a more robust file authentication system. The USPS EPM system combines trusted time stamps with content authentication technology. This combination proves document authenticity when a resulting USPS EPM is associated with a document or transaction that can later be verified using the USPS EPM repository. Finally, the service enables digital signing applications by including support for digital certificates. The combination of these technologies maintained in the USPS EPM repository provides third party evidence to support non-repudiation of electronic transactions and is designed to detect the fraudulent tampering or inadvertent altering of electronic data.

However, the USPS EPM system has a drawback in that it requires a plug-in or software application to be installed on the user's machine (i.e., a thick client). Often, users cannot easily install new software applications on their computers, or firewall and antivirus settings may block traffic secure connections. In this scenario the plug-ins have a high barrier to overcome in terms of usage adoption. Moreover, when users want to proceed with just one transaction, they may not want to go through all the effort of downloading and installing the software.

### SUMMARY

Systems, methods, and computer products consistent with the present invention are now provided that overcome the limitations previously described by providing a digital file management system that allows for digital file authentication, distribution, and storage through a web-base interfaced that does not require the user to download a plug-in or other application. A web services module provides a web-based interface for uploading a document without the need for a plug-in. An application service module prepares the document and sends it to an EPM client. The EPM client interacts with an EPM server (for example, a USPS EPM server) to get an EPM for the document. The application services module embeds the EPM in the document and stores the document on a file server. A distribution engine then notifies recipients that the document is ready for retrieval. The user may then interact with the web module server to retrieve the document from the file server.

One embodiment consistent with the present invention includes method for authenticating a file in a data processing system having a digital file management (DFM) server, an electronic postmark (EPM) server, a sender, and at least one intended recipient, the method comprising the steps of receiving a file from a sender through a computing device, acquiring an EPM from the EPM server, embedding the EPM in the file, and providing the file with the EPM to the intended recipient. Acquiring an EPM may further include hashing the file to produce a hash code, digitally signing the hash code, and sending the signed hash code to the EPM server with a request for an EPM. The method may further comprise notifying the at least one intended recipient via email that the file may be retrieved using a URL in the email, and notifying the sender via email that an intended recipient retrieved the file. Still further, the method may comprise logging events associated with the file.

In another embodiment consistent with the present invention, acquiring an EPM includes acquiring an EPM from the United States Postal Service (USPS) EPM server. Receiving a file may include receiving a file from a computing device that does not include a plug-in associated with the DFM server, and receiving a file via the sender's web browser. The EPM may include a date and time stamp.

Still another embodiment consistent with the present invention includes a computer-readable medium storing computer-executable instructions for performing a method for authenticating a file in a data processing system having a digital file management (DFM) server, an electronic postmark (EPM) server, a sender, and at least one intended recipient, the method comprising the steps of receiving a file from a sender through a computing device, acquiring an EPM from the EPM server, embedding the EPM in the file, and providing the file with the EPM to the intended recipient. Acquiring an EPM may further include hashing the file to produce a hash code, digitally signing the hash code, and sending the signed hash code to the EPM server with a request for an EPM. The method may further comprise notifying the at least one intended recipient via email that the file may be retrieved using a URL in the email, and notifying the sender via email that an intended recipient retrieved the file. Still further, the method may comprise logging events associated with the file.

In another embodiment consistent with the present invention, acquiring an EPM includes acquiring an EPM from the United States Postal Service (USPS) EPM server. Receiving a file may include receiving a file from a computing device that does not include a plug-in associated with the DFM server, and receiving a file via the sender's web browser. The EPM may include a date and time stamp.

Yet another embodiment consistent with the present invention includes a file authentication system having a digital file management (DFM) server, an electronic postmark (EPM) server, a sender, and at least one intended recipient, comprising a memory storing a program that receives a file from a sender through a computing device, acquires an EPM from the EPM servers, embeds the EPM in the file, and provides the file with the EPM to the intended recipient, and a processor for executing the program. Acquiring an EPM may include hashing the file to produce a hash code, digitally signing the hash code, and sending the signed hash code to the EPM server with a request for an EPM.

Other systems, methods, features, and advantages of the invention will become apparent to one with skill in the art upon examination of the following figures and detailed description. It is intended that such additional systems, methods, features, and advantages be included within this description and be within the scope of the invention.

### BRIEF DESCRIPTION OF THE DRAWINGS

The accompanying drawings, which are incorporated in and constitute a part of this specification, illustrate an implementation of the invention and, together with the description, serve to explain advantages and principles consistent with the invention. In the drawings,

FIG. 1 illustrates an network overview of a digital file management system in accordance with an embodiment consistent with the present invention;

FIG. 2 illustrates an exemplary computer system;

FIG. 3 illustrates the components of a digital file management system in accordance with an embodiment consistent with the present invention; and

FIG. 4 illustrates a method of using a digital file management system in accordance with an embodiment consistent with the present invention.

### DETAILED DESCRIPTION

Reference will now be made in detail to an implementation consistent with the present invention as illustrated in the accompanying drawings.

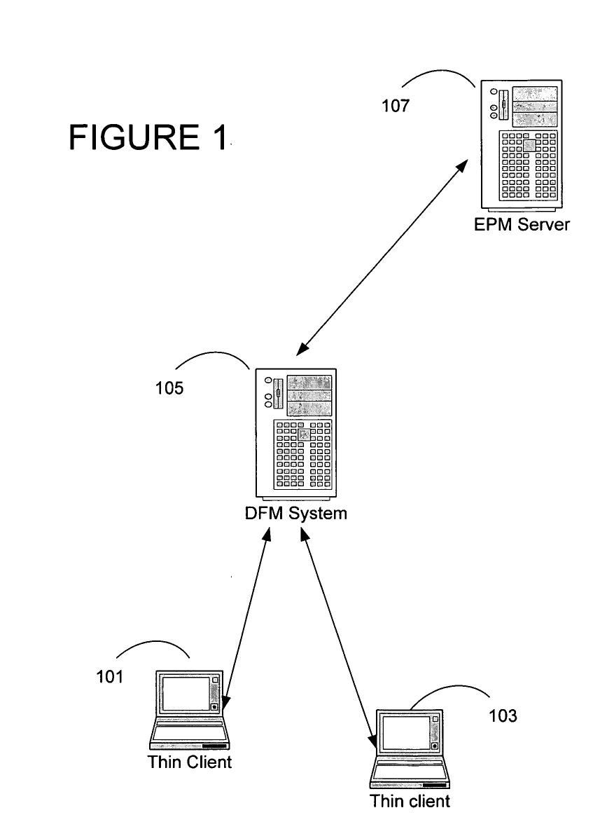

FIG. 1 schematically illustrates an overview of a system for digital file management and authentication. Thin client 101 is a computing device such as a personal computer, palm top computer, personal digital assistant, cell phone, etc., that enables a user to access a public network (e.g. the Internet) to communicate with the digital file management (DFM) system 105. Thin client 101 may upload a digital file (e.g., a word processing document) to the DFM system 105 via a typical browser, such as a web browser, without the need for a plug-in or application specific to the DFM system. In one embodiment consistent with the present invention, the DFM system 105 is the AuthentiDate SendBlue system. The DFM system 105 is explained in greater detail below. The DFM system 105 receives a document from thin client 101 and interacts with an EPM server 107 to acquire an EPM for the document. Once the document has been marked with the EPM, the DFM system 105 alerts a recipient, such as thin client 103, that the document is ready for retrieval. Though only one recipient is illustrated, there may be any number of recipients. Thin client 103 can retrieve the document without the need for a plug-in or application that is specific to the DFM system 105. However, a thick client computing device may also be a recipient.

In one embodiment consistent with the invention, the EPM server 107 is the USPS EPM server, which is now described in detail. Those of ordinary skill in the art will recognize that the EPM server 107 is not limited to the USPS EPM server, and may be any suitable equivalent.

The USPS EPM server facilitates secure electronic communication for government and commercial systems and strengthens the security, privacy, and productivity of communication in the nation's electronic future. The USPS EPM server use trusted time stamps and content authentication technology, as well as aspects of non-repudiation. The trusted time stamps are derived from the National Institute of Standards and Technology (NIST). These time stamps are auditable such that for each time stamp issued, the system is able to produce upon demand the bracketing time synchronization events starting from NIST and following a secure chain of custody through any intermediary clocks.

To prove that the contents of a file have not been tampered with, the USPS EPM server stores a hash code of the file, without actually seeing or storing the file. A hash code, also referred to as a “file signature” or “message digest,” is a number that uniquely represents (is sufficient to identify) a particular file. Hash codes are unique in the sense that two different files will never have the same hash code, except in the unlikely event of a hash collision. The likelihood of a hash collision decreases exponentially as the bit length of the hash code increases. With the 160 bit SHA-1 hashing algorithm (the industry standard) used by the USPS EPM server, the odds of a hash collision are exceedingly remote (1 in 280). Because the hashing function is ‘one-way,’ no portion of the original data can be reconstructed from the file signature (in the same way an individual cannot be “reconstructed” from his signature or fingerprint). Hashing functions are superior to their technical counterpart the checksum, in that it is not possible (or at least extremely unlikely using today's technology) to find a second file with different contents that has the same hash code. Thus, if a user can present the USPM EPM server with a hash code, it can be assumed that the person who computed that hash code had in their possession a certain file.

The USPS server uses PKI (Public Key Infrastructure) to prove identity. A digital certificate is comprised of two “keys,” one public and one private key. The public key is freely distributed, and serves to verify a signature as being created by its matching private key. The private key is held secret by the owner, and is used to sign digital transactions. Certificate Authorities (CAs) control the issuance of digital certificates, and are responsible for properly identifying the owner (also known as vetting).

A digital signature is created by signing a hash code of a file with the user's private key. Since the public key is distributed as part of the digital signature anyone viewing the signature can now verify that it was signed by the corresponding private key. In this way, both senders and receivers can associate the sender's identity with a specific file.

A core strength of PKI is strong user-level authentication and digital signing (proving who did what). The USPS EPM server extends the trust of PKI by adding trusted time stamps, checking that the signing certificate is not expired, and archiving the transaction for long term non-repudiation. Therefore, the USPS EPM server is complementary to PKI, but the USPS EPM server user does not need to use PKI in order to use the EPM. The USPS EPM server also uses PKI to establish a secure, tamper-proof connection between the customer's network and the USPS EPM repository. The USPS EPM repository is issued server-level PKI digital certificates so that users can trust the service maintaining their file/document digital signatures.

Time-Stamping is a process whereby a trusted third party signs a hash code with the current time. There is a protocol for time stamping—the Internet Engineering Task Force (IETF) 3161, that defines how hash codes are signed with a time stamp. This protocol is an anonymous protocol, meaning the identity of the submitter of the hash code is not associated with the file. The private key used for signing is that of the Time Stamping Authority (TSA). The TSA certifies (in the case of the USPS EPM, the TSA is the United States Postal Service) that the time stamp issued is accurate. This avoids the problem of relying on an individual computer clock for time stamping, since the time and date functions in a computer are relatively easy to manipulate.

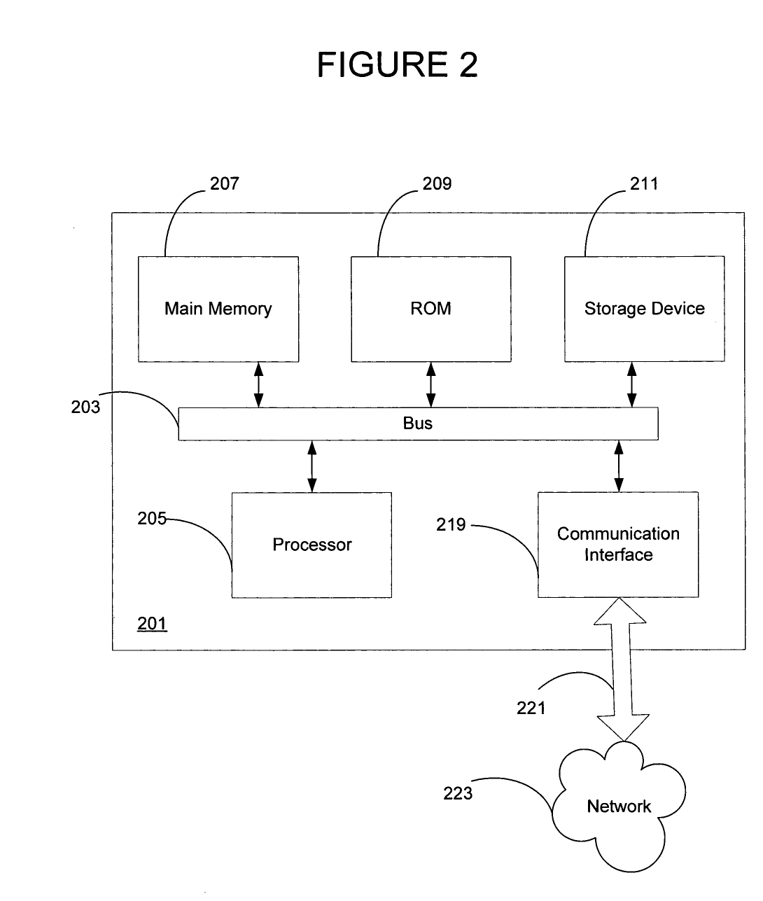

Turning to FIG. 2, an exemplary computer system that can be configured as all or part of the DFM system consistent with various embodiments in accordance with the present invention is now described. Computer system 201 includes a bus 203 or other communication mechanism for communicating information, and a processor 205 coupled with bus 203 for processing the information. Computer system 201 also includes a main memory 207, such as a random access memory (RAM) or other dynamic storage device, coupled to bus 203 for storing information and instructions to be executed by processor 205. In addition, main memory 207 may be used for storing temporary variables or other intermediate information during execution of instructions to be executed by processor 205. Computer system 201 further includes a read only memory (ROM) 209 or other static storage device coupled to bus 203 for storing static information and instructions for processor 205. A storage device 211, such as a magnetic disk or optical disk, is provided and coupled to bus 203 for storing information and instructions.

According to one embodiment, processor 205 executes one or more sequences of one or more instructions contained in main memory 207. Such instructions may be read into main memory 203 from another computer-readable medium, such as storage device 211. Execution of the sequences of instructions in main memory 207 causes processor 205 to perform the process steps described herein. One or more processors in a multi-processing arrangement may also be employed to execute the sequences of instructions contained in main memory 207. In alternative embodiments, hard-wired circuitry may be used in place of or in combination with software instructions. Thus, embodiments are not limited to any specific combination of hardware circuitry and software.

Further, the instructions to support the system interfaces and protocols of system 100 may reside on a computer-readable medium. The term “computer-readable medium” as used herein refers to any medium that participates in providing instructions to processor 205 for execution. Common forms of computer-readable media include, for example, a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read.

Computer system 201 also includes a communication interface 219 coupled to bus 203. Communication interface 219 provides a two-way data communication coupling to a network link 221 that is connected to a local network 223. For example, communication interface 219 may be a network interface card. As another example, communication interface 219 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 219 sends and receives electrical, electromagnetic or optical signals that carry digital data streams representing various types of information.

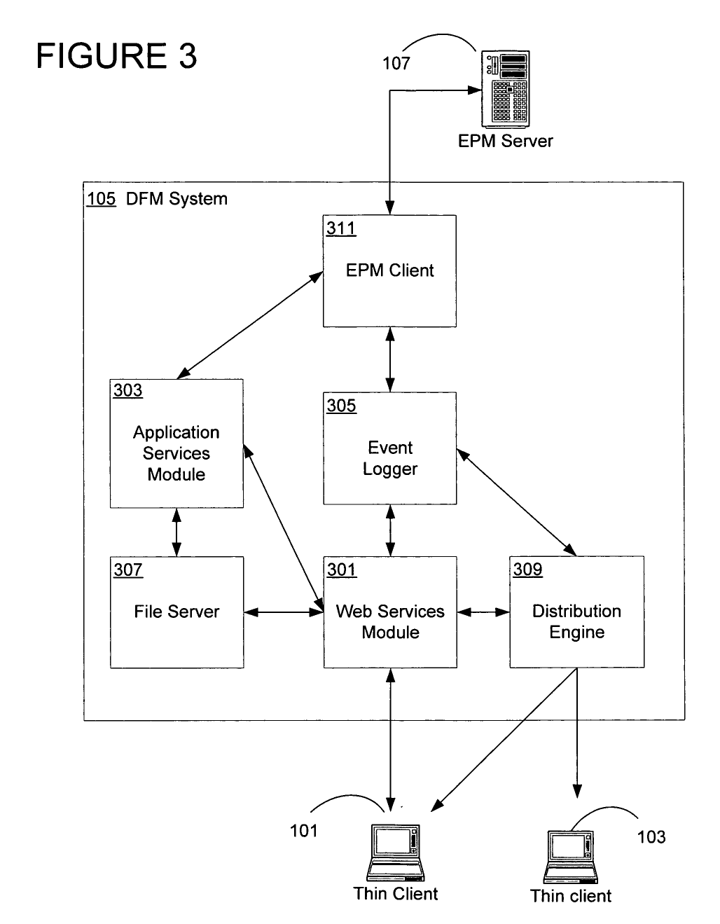

Turning attention to FIG. 3, a DFM system consistent with the present invention is now described. DFM system 105 includes a web services module 301, an application services module 303, an event logger 305, a file server 307, a distribution engine 309, and an EPM client 311. Those of ordinary skill in the art will recognize that web services module 301, application services module 303, event logger 305, file server 307, distribution engine 309, and EPM client 311 may be implemented in one computing device or distributed among a plurality of computing devices alone or in any combination.

Web services module 301 provides the user interface for interacting with a sender or recipient. Web services module 301 allows a user to upload a document to the DFM system 105, and also retrieves the document for the intended recipient(s). When a sender first uses the DFM system 105, they must register with the system and select a user name and a password for future log-in. This registration is achieved via the web services module 301. Web services module 301 also works with the distribution engine to coordinate the distribution of email notification to senders and recipients.

Application services module 303 receives uploaded documents and user log-in information from the web services module 301. The application services module 303, upon first use by a user, assigns user credentials including a digital signature (for example, a PKI public/private key pair) to the user, and uses the user log-in information to look up the user credentials upon future use of the DFM system. In another embodiment of the invention, the application services module 303 obtains user credentials for the user from a certificate authority, stores the credentials, and uses the user log-in information to look up the user credentials upon future use of the DFM system. The application services module 303 also hashes documents and signs hash code with the digital signature of the user. The application services module 303 provides the signed hash code to the EPM client 311. When the EPM is received from the EPM client 311, the application services module 303 embeds the EPM in the document and sends the document with the EPM to file server 307.

EPM client 311 receives signed hash code from the application services module 303 and sends the signed hash to the EPM server 107 for time/date stamping. This time/date stamp is signed by the EPM server's digital signature to generate the EPM, which is then stored in an EPM repository of the EPM server 107. The EPM client 311 acquires the EPM from the EPM server 107 and sends it to application services module 303. In one embodiment consistent with the present invention, the EPM client 311 is the USPS EPM SDK.

Distribution engine 309 is notified by web services module 301 when a sent document is ready for retrieval. Web services module 301 with a Uniform Resource Locator (URL) for the document as well as the email addresses of the sender intended recipient(s). Distribution engine 309 sends an email to the intended recipient(s), the email including the URL, and instructs the recipient(s) to retrieve the document via the URL. When a recipient does retrieve the document, web services module 301 notifies distribution engine 309, and distribution engine 309 sends a return receipt notification to the sender indicating that the document was received.

Event logger 305 communicates with web services module 301, EPM client 311, and distribution 309 to log event of the DFM system 105, including receipt of a document from a sender, receipt of an EPM for the document, notification to intended recipient(s), retrieval by intended recipient(s), and notification of receipt to the sender. Based on the records of event logger 305, web services module 301 allows senders and recipients of documents to view all of the events logged by the event logger 305.

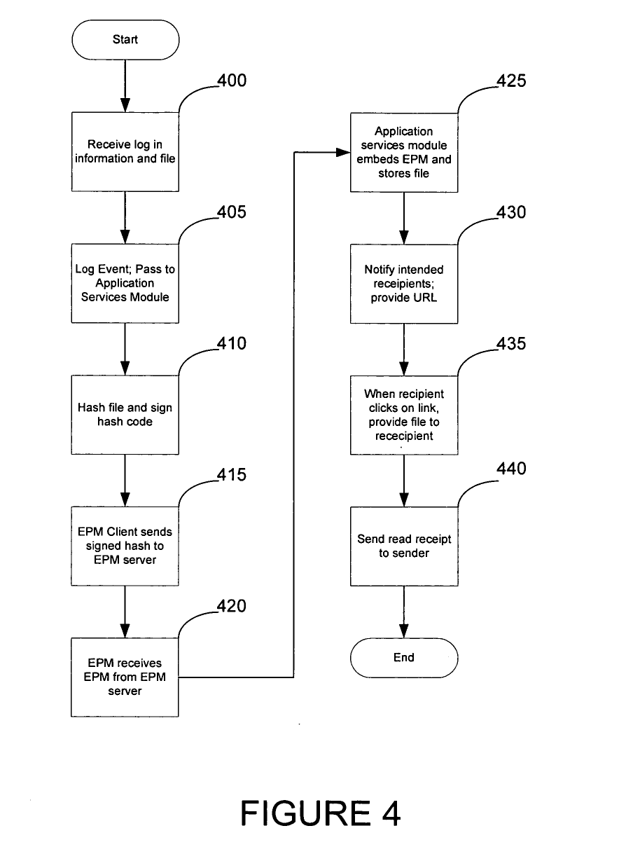

Turning attention to FIG. 4, and with continued reference to FIG. 3, a method of using the DFM system 105 consistent with the present invention is now described. At step 400, a user logs into the DFM system 105 via the web services module 301 and uploads a digital file. If the user is a new user, registration with the DFM system precedes the log-in and upload of the file. By way of example and not limitation, the digital file may be a word processing document or a portable document format (PDF) document. The user may upload the file using a simple web browser viewing a web page served by web services module 301. For example, the user may select a “browse” button on the web page, select the file stored on the user's machine, and select an “upload” button to upload the file to the DFM system 105 via the web services module 301. Thus, no plug-in or other application is need to interact with the DFM system 105.

At step 405, the web services module 301 receives the user's file and log-in information, and notifies the event logger 305 that a file was received so that the event logger may log the receipt. The web services 301 server passes the file and user information to the application services module 303. In one embodiment consistent with the invention, there is an application services module for each file format, for example, an application services module for .doc files and an application services module for .pdf files. In this case, the web services module 301 selects the appropriate application services module according to the file type of the file.

At step 410, the application services module 303 receives the file and user information. The application services module 303 identifies the user and selects a digital signature associated with the user. The application services module 303 hashes the file, and signs the hash code with the digital signature associated with the user. This signed hash coded is passed to the EPM client 311. At step 415, the EPM client 311 submits the signed hash code to the EPM server. The EPM client 311 then receives an EPM for the file from the EPM server at step 420. The EPM client 311 passes the EPM to the application services module 303 and notifies the event logger 305 that the EPM was received for the file. At step 425, the application services module 303 embeds the EPM in the file, stores the file in file server 307, and notifies web services module 301 that the file is ready for viewing.

At step 430, web services module 301 instructs distribution engine 309 to notify the intended recipient(s). Web services server provides distribution engine 309 with email addresses for the intended recipient(s), as well as a URL for the file. Distribution engine 309 sends an email containing the URL to the intended recipient(s), and notifies event logger 305 of the event. At step 435, a recipient retrieves the file via the URL. Web services module 301 receives the request and retrieves the file from file server 307 for the recipient. Web module 301 also notifies event logger 305 of the event, and instructs distribution engine 309 to send an email to the sender indicating the document has been retrieved by an intended recipient (step 440).

While there has been illustrated and described embodiments consistent with the present invention, it will be understood by those skilled in the art that various changes and modifications may be made and equivalents may be substituted for elements thereof without departing from the true scope of the invention. Therefore, it is intended that this invention not be limited to any particular embodiment disclosed, but that the invention will include all embodiments falling within the scope of the appended claims.

We claim:

1. A method for authenticating a file in a data processing system having a digital file management (DFM) server, an electronic postmark (EPM) server, a sender, and at least one intended recipient, the method comprising the steps of:
receiving a file from a sender through a computing device;
acquiring an EPM from the EPM server;
embedding the EPM in the file; and
providing the file with the EPM to the intended recipient.

2. The method of claim 1, wherein acquiring an EPM includes:
hashing the file to produce a hash code;
digitally signing the hash code; and
sending the signed hash code to the EPM server with a request for an EPM.

3. The method of claim 1, further comprising notifying the at least one intended recipient via email that the file may be retrieved using a URL in the email.

4. The method of claim 1, further comprising notifying the sender via email that an intended recipient retrieved the file.

5. The method of claim 1, further comprising logging events associated with the file.

6. The method of claim 1, wherein acquiring an EPM includes acquiring an EPM from the United States Postal Service (USPS) EPM server.

7. The method of claim 1, wherein receiving a file includes receiving a file from a computing device that does not include a plug-in associated with the DFM server.

8. The method of claim 1, wherein receiving a file includes receiving a file via the sender's web browser.

9. The method of claim 1, wherein the EPM includes a date and time stamp.

10. A computer-readable medium storing computer-executable instructions for performing a method for authenticating a file in a data processing system having a digital file management (DFM) server, an electronic postmark (EPM) server, a sender, and at least one intended recipient, the method comprising the steps of:
receiving a file from a sender through a computing device;
acquiring an EPM from the EPM server;
embedding the EPM in the file; and
providing the file with the EPM to the intended recipient.

11. The computer-readable medium of claim 10, wherein acquiring an EPM includes:
hashing the file to produce a hash code;
digitally signing the hash code; and
sending the signed hash code to the EPM server with a request for an EPM.

12. The computer-readable medium of claim 10, further comprising notifying the at least one intended recipient via email that the file may be retrieved using a URL in the email.

13. The computer-readable medium of claim 10, further comprising notifying the sender via email that an intended recipient retrieved the file.

14. The computer-readable medium of claim 10, further comprising logging events associated with the file.

15. The computer-readable medium of claim 10, wherein acquiring an EPM includes acquiring an EPM from the United States Postal Service (USPS) EPM server.

16. The computer-readable medium of claim 10, wherein receiving a file includes receiving a file from a computing device that does not include a plug-in associated with the DFM server.

17. The computer-readable medium of claim 10, wherein receiving a file includes receiving a file via the sender's web browser.

18. The computer-readable medium of claim 10, wherein the EPM includes a date and time stamp.

19. A file authentication system having a digital file management (DFM) server, an electronic postmark (EPM) server, a sender, and at least one intended recipient, comprising:
a memory storing a program that receives a file from a sender through a computing device, acquires an EPM from the EPM servers, embeds the EPM in the file, and provides the file with the EPM to the intended recipient; and
a processor for executing the program.

20. The file authentication system of claim 19, wherein acquires an EPM includes:
hashes the file to produce a hash code;
digitally signs the hash code; and
sends the signed hash code to the EPM server with a request for an EPM.
